(19) United States
(12) Patent Application Publication
(10) Pub. No.: US 2007/0080804 A1
(43) Pub. Date: Apr. 12, 2007

(54) Systems and methods for enhanced RFID tag performance

(76) Inventors: Edwin Hirahara, Federal Way, WA (US); David L. Lee, Tacoma, WA (US); Paul Spencer, Pullman, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/246,506

(22) Filed: Oct. 7, 2005

(51) Int. Cl. G08B 13/14

(52) U.S. Cl. 340/572.1

(57) ABSTRACT

A radio frequency identification system (20) generally includes at least one container (22), a radio frequency identification tag (24) capable of transmitting a radio frequency signal associated with the container, and a radio frequency device, such as a repeater (26) associated with the radio frequency identification tag or the container for enhancing readability of the radio frequency signal.

### FIELD OF THE INVENTION

Embodiments of the present invention relate generally to radio frequency identification (RFID) tag performance and, more specifically, to systems and methods of enhancing the radio frequency identification of objects, such as containers.

### BACKGROUND OF THE INVENTION

Radio frequency identification (RFID) tags are small integrated circuits which are attached to containers, packages, or individual goods. They are used to store information about the item such as price, serial number, and shipping information (including tracking number, shipping date, arrival date, as well as other information). RFID tags are read using an RFID receiver or reader which transmits a radio frequency interrogation signal to the tags. The tag detects the reader interrogation signal and replies by transmitting a response signal that contains the information stored in the RFID tag. The RFID reader detects the response signal from the RFID tag and stores the information in its memory. Some RFID tags contain a battery, while others store the energy of the received interrogation signal and use that energy to power their circuits.

Environmental, material, and electromagnetic conditions all affect the performance of RFID tags. Different physical mechanisms that affect the propagation of electromagnetic or radio waves include reflection or scattering, re-radiation, shielding, absorption, and spreading loss. In a space free of any obstructions or absorption mechanisms, the strength of a radio frequency signal declines in inverse proportion to the square of the distance. For an electromagnetic wave propagating through a region in which signal modifications can arise from the ground and from obstacles (particularly conductors, such as metal or liquid obstacles), the reduction in strength over distance is greater and the signal path can vary considerably. The disruptive materials may be the goods within their packaging, the surface of the goods themselves, or the walls of the exterior container.

As a result, a reader interrogation signal is often redirected and attenuated before it actually reaches the RFID tag. And, similarly, the response signal from the RFID tag is often redirected and attenuated before it actually reaches the reader. This means that the contents of the container as well as the composition of the container can strongly influence whether 100% tag readability can be achieved in practice. In a radio frequency identification system, 100% tag readability means that all RFID tags representing their respective tagged items are identified and “counted” through data transfer with a reader.

Some advancements have been made to enhance RFID tag readability, such as optimizing the placement of RFID tags on containers or increasing the time that the container is in the radio frequency reader field to allow sufficient time for resolution of signal overlaps, signal averaging, or greater power accumulation in the RFID tag. These advancements, however, fail to accommodate all attenuation, particularly electromagnetic wave absorption.

Therefore, there exists a need to enhance radio frequency transmission in response to environmental influences, both internal and external, on the range of transmission. Such technology would have immediate value in the packaging, shipping, and retail industries.

### SUMMARY OF THE INVENTION

In accordance with aspects of the present invention, a combination container and radio frequency identification system is provided. The system includes at least one container having a container body. A radio frequency identification tag is associated with at least one container body, wherein the radio frequency identification tag is capable of transmitting a radio frequency signal. At least one discrete radio frequency device is associated with the radio frequency identification tag or at least one container body for enhancing readability of the radio frequency signal.

In accordance with other aspects of the present invention, a method of increasing readability of a radio frequency identification tag is provided. The method includes obtaining a container and associating at least one radio frequency identification tag with the container, wherein at least one radio frequency identification tag is capable of transmitting a radio frequency signal. The method further includes associating at least one radio frequency device with the radio frequency identification tag or the container, wherein at least one radio frequency device enhances readability of the radio frequency signal.

In accordance with other aspects of the present invention, another method of enhancing readability of a radio frequency identification tag is provided. The method includes receiving the interrogation signal transmitted from the reader or receiving the response signal transmitted from the radio frequency identification tag. The method further includes enhancing the received interrogation signal to enable readability by the radio frequency identification tag or enhancing the received response signal to enable readability by the reader.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective view of an exemplary embodiment of a radio frequency identification system formed according to various aspects of the present invention;

FIGS. 2-4 are perspective views of other exemplary embodiments of radio frequency identification systems formed according to various aspects of the present invention;

FIG. 5 is a schematic of a general loss path for electromagnetic waves through an exemplary container in a conventional radio frequency identification system;

FIG. 6 is a functional block diagram of a radio frequency identification system according to the embodiment of FIG. 1;

FIG. 7 is a perspective view of another exemplary embodiment of a radio frequency identification system formed according to various aspects of the present invention;

FIG. 8 is a functional block diagram of a radio frequency identification system according to the embodiment of FIG. 4;

FIG. 9 is a functional block diagram of a radio frequency identification system according to another exemplary embodiment; and

FIGS. 10-11 are perspective views of other exemplary embodiments of radio frequency identification systems formed according to various aspects of the present invention.

### DETAILED DESCRIPTION OF THE EXEMPLARY EMBODIMENTS

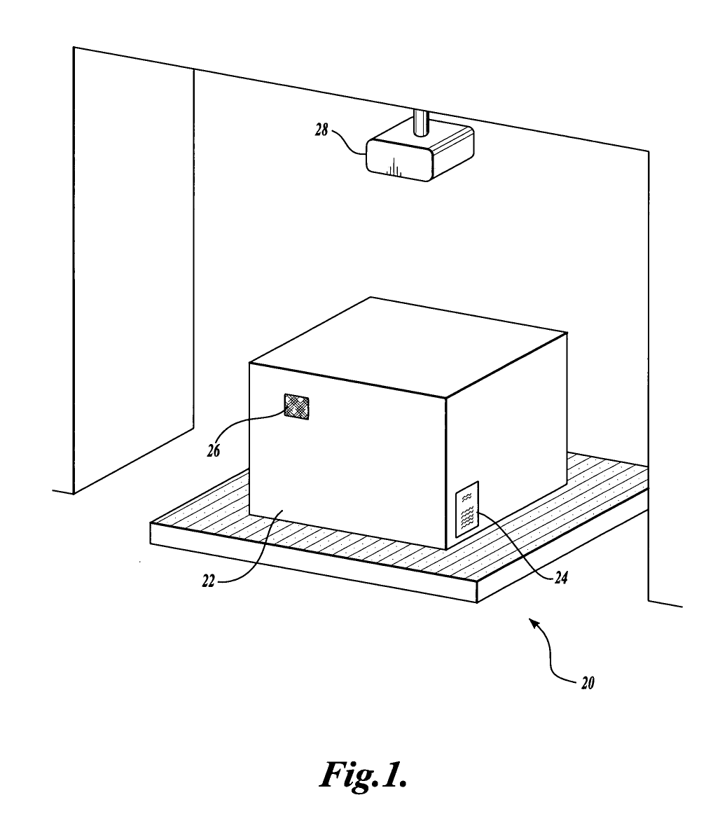

Embodiments of the present invention are directed to systems and methods for enhancing radio frequency identification of at least one object, such as a container. A combination container and radio frequency identification system 20 constructed in accordance with one embodiment of the present invention may be best understood by referring to FIG. 1. The system 20 generally includes at least one container 22, a radio frequency identification tag 24 (hereinafter “RFID tag 24”) capable of transmitting a radio frequency signal associated with the container 22, and a discrete radio frequency device, such as a repeater 26, associated with the RFID tag 24 or the container 22 for enhancing readability of the radio frequency signal, for example, by a radio frequency receiver or reader 28.

In one embodiment, the container 22 includes a body of substantially electrically non-conductive material, such as paper, cardboard, paperboard, corrugated paperboard, fiberform, or like cellulosic materials. For example, in the illustrated embodiment of FIG. 1, the container 22 is a substantially cubic box manufactured primarily from corrugated paperboard. The container 22 comprises multiple walls having a first linerboard and a second linerboard with a corrugated filler between the first and second linerboard, as generally known and used in the art. The thickness of the container walls depends upon the thickness of the linerboards, as well as the thickness of the corrugated filler therebetween.

Although the container 22 in the illustrated embodiment is manufactured from corrugated paperboard, it will be appreciated that other containers made from other materials are also within the scope of the invention. As non-limiting examples, the container may be formed from metals (such as foils), wood, plastics (such as shrink wrap or pouch-packets), glass, or any other materials or combinations thereof. Also as non-limiting examples, the container may include a body of substantially electrically conductive material or a body of non-conductive material. In addition, the container may be of another three-dimensional shape besides substantially cubic shape. As non-limiting examples, the container may be rectangular, prismatic, cylindrical, or any other three-dimensional shape. As will be discussed in greater detail below, varying container materials result in varying radio frequency signal attenuation due to material absorption and/or reflection. Therefore, container material should be considered a contributing factor in the design of a sufficient radio frequency enhancement system.

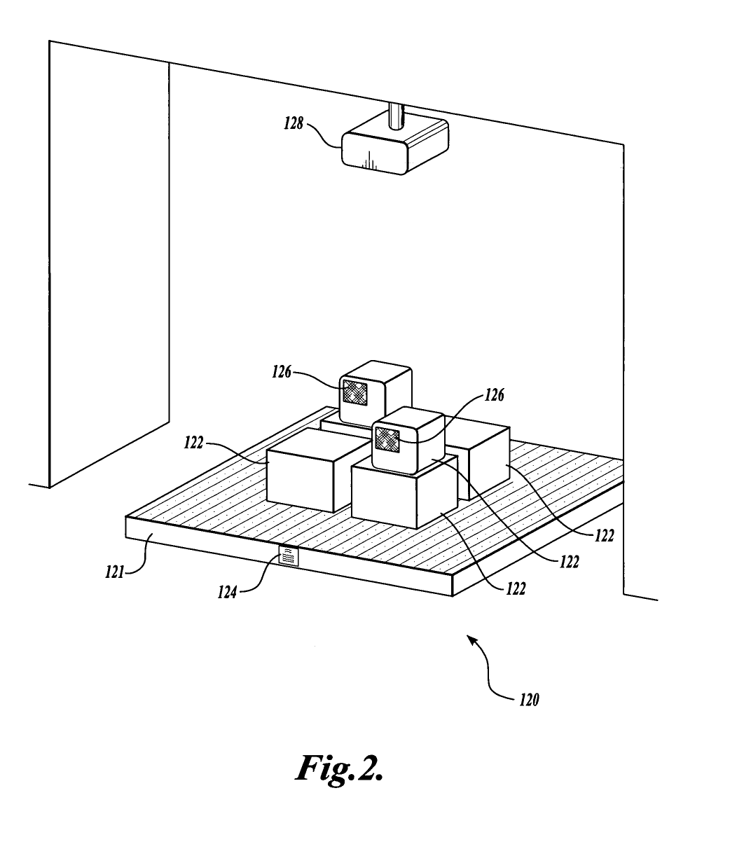

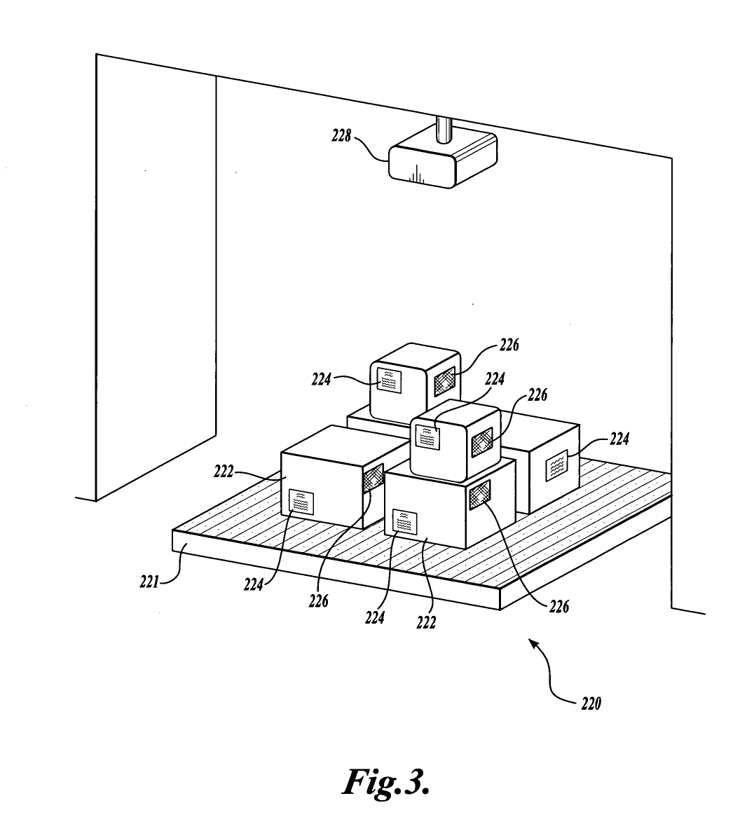

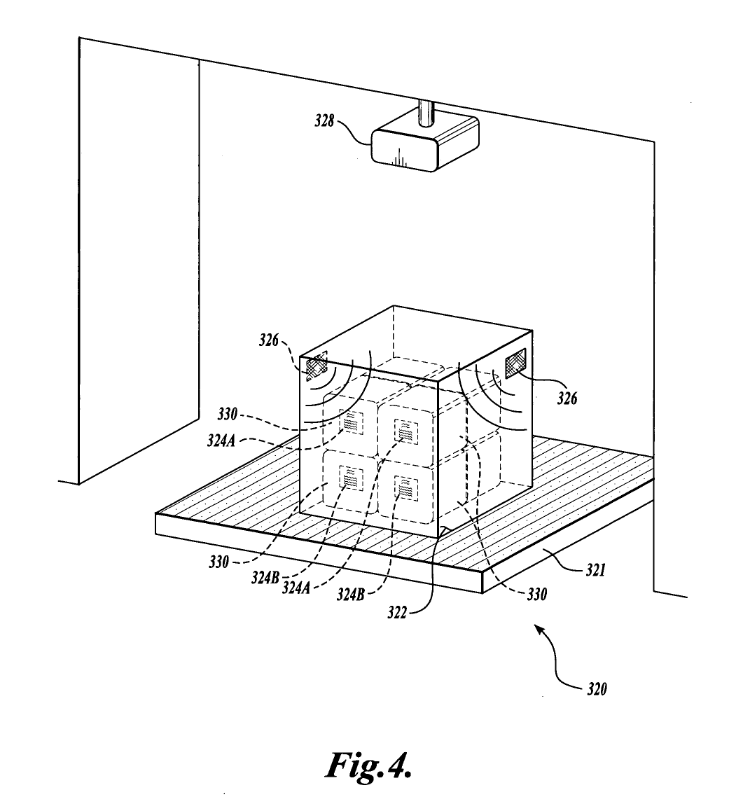

While FIG. 1 illustrates one container 22 and one RFID tag 24 associated with the container 22, it will be appreciated that other designs and configurations are also within the scope of the invention. As non-limiting examples, the system 120 may optionally include a pallet 121 supporting one or more containers 122 and having an RFID tag 124 associated with the pallet 121 (see FIG. 2); the system 220 may optionally include a pallet 221 supporting a plurality of containers 222, each having an RFID tag 224 associated therewith (see FIG. 3); or the system 320 may optionally include a pallet 321 supporting a single container 322 having multiple RFID tags 324A and 324B on distinct containers and/or goods 330 housed within the container 322 (e.g., as cans of soup, boxes of laundry detergent, reams of paper, lumber, electronics, or any other goods) (see FIG. 4). In addition, the system may optionally include any derivation or combination of the foregoing non-limiting examples, such as a pallet supporting multiple containers having multiple RFID tags, including one RFID tag on each container, one RFID tag on each distinct product within each container, and one RFID tag on the pallet itself.

In embodiments of the present invention, the RFID tags may be, for example, positioned on the external surface of the container body, inside the container body, or affixed to goods (which may also be containers, such as cans of soup, boxes of laundry detergent, reams of paper, lumber, electronics, etc.) inside the container body. Returning to FIG. 1, the RFID tag 24 will now be described in greater detail. The RFID tag 24 is generally manufactured using integrated circuit technology, programmed with a unique identifier, and assembled with either a printed circuit antenna, a printed conductive ink antenna, or an antenna fabricated from small wires. As a non-limiting example, the RFID tag 24 may be a flat assembly for incorporation into a label or a tag.

The RFID tag 24 may be categorized as either active or passive, both of which may be practiced with embodiments of the present invention. Active RFID tags are powered by an internal battery and are typically read/write, which means that tag data can be read as well as rewritten and/or modified. An active tag's memory size varies according to application requirements; some systems operate with up to 1 MB of memory. In a typical read/write RFID system, an RFID tag contains associated identification and content data in the form of encoded data. The RFID tag can also receive information from a reader in the form of encoded data. This encoded data then becomes part of the history of the tagged container or good. The battery-supplied power of an active RFID tag generally gives it a greater radio frequency receiving and outputting range. Trade-offs for active RFID tags, however, include greater size, greater cost, and limited operational life.

Passive RFID tags, on the other hand, operate without a separate external power source and obtain their operating power as it is generated from the reader. Passive RFID tags are consequently much lighter and less expensive than active tags, and they offer a virtually unlimited operational lifetime. The trade-offs for passive RFID tags include shorter radio frequency receiving and outputting ranges than active RFID tags, requiring a higher-powered reader.

Whether the RFID tag 24 is active or passive, the RFID tag 24 is capable of receiving a radio frequency signal and outputting content or identification data that is stored in its memory as a radio frequency signal. As will be described in detail below, the RFID tag 24 is capable of receiving interrogation signals from the reader 28 (or the repeater 26), and based on the received interrogation signal, generates and transmits a radio frequency signal carrying content and identification data. Because RFID tags that are capable of receiving a signal and outputting content or identification data as a signal are well known in the art, a further description of RFID tags will not be contained herein. However, it will be appreciated that any conventional or future-developed RFID tags that are capable of receiving a radio frequency signal and outputting content or identification data as a radio frequency signal, including the inductance and capacitance type, may be practiced with embodiments of the present invention.

It will be appreciated that the consideration of whether a passive or active RFID tag is employed in a radio frequency identification system 20 is part of the calculus of optimizing or enhancing the accuracy of the system. The transmission of signals between the reader, the RFID tag (whether passive and active), and the repeater, as well as system optimization, will be discussed in greater detail below.

As was discussed above, the RFID tag 24 is read by a radio frequency reader 28. The reader 28 may be any conventional RFID tag reader 28 known in the art and thus will not be described in any more detail. The radio frequency reader 28 shown in FIG. 1 is a fixed reader. It will be appreciated, however, that enhancing the readability of RFID tags by employing non-fixed readers (such as a handheld reader device) is also contemplated and therefore within the scope of the invention. In use, the reader 28 may transmit radio frequency interrogation signals at ranges of anywhere from 1 inch to 100 feet or more, depending on the reader power output and the radio frequency employed. It will be appreciated, however, that other distances are also within the scope of the invention. As will be discussed in detail below, the area of transmission of the reader signals makes up a reader communication field.

When an RFID tag 24 passes through or is located within the reader communication field, the RFID tag detects a reader interrogation signal and responds by transmitting a modulated radio frequency signal carrying content or identification data associated therewith. The content and identification data carried by the radio frequency signal typically corresponds to the container that is associated with the RFID tag and includes information such as destination information, model and serial numbers, customer numbers, instructions for handling, etc. The reader then detects the response signal transmitted by the RFID tag by its associated antenna and decodes or demodulates the response signal to obtain the associated content or identification data, as known in the art. The content or identification data may then be passed to a host computer for processing, as known in the art.

Sometimes the RFID tag cannot receive the interrogation signal or the interrogation signal is too weak to cause the RFID tag to generate and transmit its identity and content data. Thus, accurate and reliable detection of RFID tags is an ongoing problem in conventional RFID systems. Accurate and reliable detection of RFID tags is made difficult by a number of factors including, for example, the following: (a) RFID tags have a limited amount of power available to operate for responding to a signal transmission from a reader; (b) RFID tags with undersized antennas frequently cannot pick up interrogation signals transmitted by a reader; (c) readers have output strength limitations set by national governmental organizations (for example, by the U.S. Federal Communications Commission) for safety reasons; (d) the orientation of the RFID tags may be unsuitable for absorbing sufficient power from the signal transmitted by the reader; (e) the orientation of the RFID tags may be unsuitable for providing a transmitted signal sufficient for accurate reception by the reader; (f) cooperation of the RFID tags with the reader may require sophisticated logic in the transceiver to accurately perform the RFID tag portion of a communication protocol used to obtain an open communication channel between the reader and a single RFID tag; (g) multiple RFID tags transmitting simultaneously may cause a so-called radio frequency signal “collision”; (h) environment conditions, such as ice, rain-water, condensation, and humidity affect signal transmission; and (i) environmental “noise” causes interference with the interrogation and response signals.

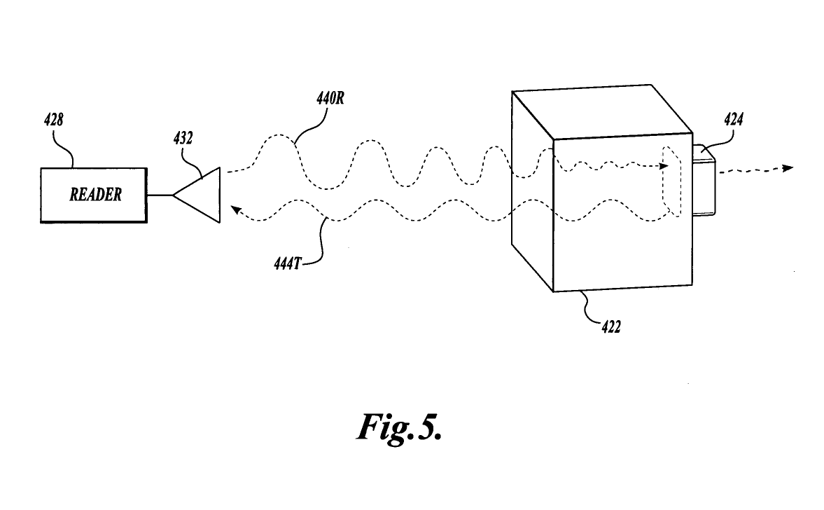

Factors (c), (d), (e), (f), (g), (h), and (i) identified above are generally associated with signal strength, orientation, and simultaneous transmission, and thus, the loss path or signal attenuation of the reader interrogation signals or the RFID tag response signals. Factors (a) and (b) are generally associated with RFID tag limitations for receiving and responding to a reader interrogation signal. An exemplary loss path is illustrated in FIG. 5. The reader antenna 432 propagates an interrogation signal 440R, which is optionally oriented to travel in a direction toward the target RFID tag 424. As the reader interrogation signal 440R travels, the signal is attenuated by spreading loss based on the distance it travels, reflection off of obstacles (such as metal objects within the container 422 or the container 422 itself), and absorption by products (such as liquid products within the container 422 or the container 422 itself). The attenuated reader interrogation signal 440R, if received by the RFID tag 424 antenna (not shown) with sufficient signal strength, causes the RFID tag 424 to respond by the generation and transmission of a response signal 444T carrying content and identification data.

The response signal 444T is subject to similar limitations and attenuation factors that the reader interrogation signal 440R is subject to. However, reader antennas in general may be larger than the RFID tag antennas, thus having stronger reception capabilities and enabling detection of attenuated signals. In this regard, the reader antenna 432 may be able to detect and receive attenuated response signals 444T transmitted from the RFID tag 424 much more readily than the RFID tag 424 is able to detect and receive attenuated interrogation signals 440R transmitted from the reader 428. Thus, if the RFID tag 424 response signal 444T has sufficient signal strength to be detected by the reader antenna 432, the response signal 444T carrying content and identification data is, in turn, received by the reader 428.

To address, or potentially mitigate, the low signal strength and signal attenuation factors (c), (d), (e), (f), (g), (h), and (i), the RFID tag limitations (a) and (b), as well as other factors, in accordance with aspects of the present invention, the system 20 may include at least one radio frequency device 26 for enhancing the readability of the radio frequency signal, as best shown in FIG. 1.

As seen in FIG. 1, one embodiment of the radio frequency device is a repeater 26. For example, if the RFID tag 24 cannot receive radio frequency signals due to signal reflection, scattering, absorption, or spreading loss, the repeater 26 can assist by repeating the same signal from a subsequent location. Such signal repeating may include retransmitting for active repeaters or reradiating for passive repeaters. In embodiments of the present disclosure, one or more repeaters may be added to an RFID system to enhance RFID tag performance. In practice, as many repeaters may be added to the system as required to create an optimized system, with the goal of the system being 100% readability accuracy.

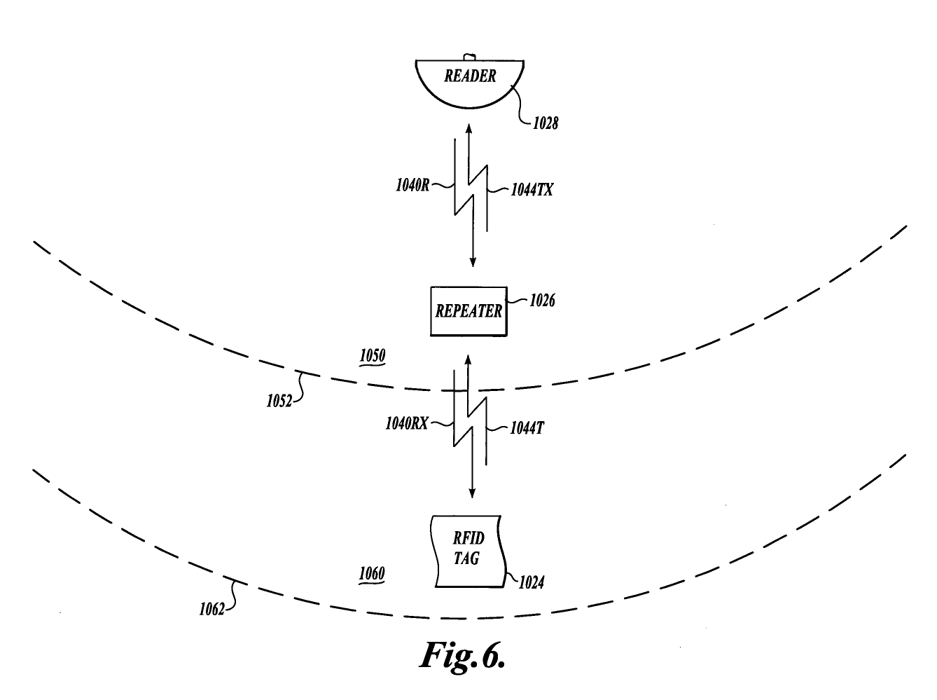

Turning now to FIG. 6, there is shown a functional block diagram of the radio frequency identification system depicted in the exemplary embodiment of FIG. 1. In that regard, the RFID tag 24 (located on container 22) is represented by block 1024; the repeater 26 is represented by block 1026; and the reader 28 is represented by block 1028. As will be discussed in detail below, arrows 1040R, 1040RX, 1044T, and 1044TX in FIG. 6 represent the radio frequency signals sent from the reader 1028, the repeater 1026, and the RFID tag 1024. The area of transmission of the reader interrogation signal 1040R is the reader communication field 1050 marked by reader communication field boundary 1052. The area of transmission of repeated interrogation signal 104ORX is the repeater communication field 1060 marked by repeater communication field boundary 1062.

The repeater 1026 is generally associated with the RFID tag 1024 to receive the interrogation signal 1040R from the reader 1028 and to retransmit (or reradiate) signal 1040R as signal 1040RX at an appropriate retransmission strength and in multiple directions. Specifically, these “multiple directions” may include directions other than the direction of the propagation of the signal (for example, signals 1040R or 1044T) received by the repeater 1026. Likewise, the repeater 1026 may receive the response signal 1044T from the RFID tag 1024 and retransmit (or reradiate) signal 1044T as signal 1044TX at an appropriate retransmission strength and in multiple directions. As will be discussed in detail below, the repeater 1026 also may receive a radio frequency signal from another repeater (not shown) and retransmit (or reradiate) the repeater signal at an appropriate retransmission strength and in multiple directions. Thus, the repeater 1026 may be any conventional radio frequency repeater capable of, for example, receiving an interrogation signal 1040R from the reader 1028 and retransmitting (or reradiating) the received reader interrogation signal 1040R as signal 1040RX at an appropriate retransmission strength and in multiple directions and thus will not be described in any more detail. It will be appreciated that an appropriate retransmission strength will be dependent on the entire system, in addition to the transmission strength of the reader, and can vary according to the desired application.

In one embodiment, the radio frequency repeater 1026 may be an active radio frequency repeater, and thus, the received reader interrogation signal 1040R may be amplified prior to retransmission as repeated signal 1040RX. It will be appreciated that the frequency and timing of repeated signal 1040RX may be arranged to prevent self-oscillation by an active repeater or by a system of active repeaters if multiple active repeaters are used. It will also be appreciated that the active repeater may be of any known configuration, including conventional components known in the art.

In other embodiments, the radio frequency repeater 1026 may be passive. In such an embodiment, the passive repeater may include an antenna and a conventional tank or tuned circuit. In use, the tank circuit resonates once the reader interrogation signal 1040R is received from the antenna and reradiates the received reader interrogation signal 1040R as repeated signal 1040RX. In another embodiment, the passive repeater may include a signal reflecting apparatus, such as a metallic object or a system of metallic objects, such as pipes or wires. In use, the signal reflecting apparatus changes the direction of the electromagnetic radiation propagation direction by reflection to send the signal to a more useful location (e.g., into a stack of containers on a pallet to RFID tags located on goods housed within the containers, or out of the containers to the RFID reader).

Such embodiments enhance the readability of the RFID tag by either reflecting the interrogation signal, providing a more efficient signal pathway, or selectively distorting (i.e., changing) the wave form of the interrogation signal and, therefore, such embodiments are also within the scope of radio frequency devices of the present disclosure.

In several embodiments, it will be appreciated that the repeater 1026 may retransmit (or reradiate) the reader interrogation signal 1040R as repeater signal 1040RX over varying distances, for example, from 1 inch to 100 or more, as known in the art. Other distances, however, are within the scope of the present invention.

The repeater 1026 may be located in proximity to the RFID tag 1024 for enhancing the readability of the repeater signal 1040RX by the RFID tag 1024 and for enhancing the readability of the response RFID tag signal 1044T by the repeater 1026. Although the RFID tag 1024 and the repeater 1026 may be in proximity and in communication with one another, it will be appreciated that the repeater 1026 is a discrete component and, as such, is not physically attached to the RFID tag 1024 in the way that an antenna would be physically attached. Rather, the repeater 1026 and the RFID tag 1024 communicate via the transmission of, for example, signals 1040RX and 1044T. In addition, the repeater 1026 may be located in proximity to the reader 1028 for enhancing the readability of the reader signal 1040R by the repeater 1026 and for enhancing the readability of the repeater signal 1044TX by the reader 1028. Moreover, the repeater 1026 may be located in proximity to any other intermediate repeater for enhancing the readability of signals between intermediate repeaters (not shown).

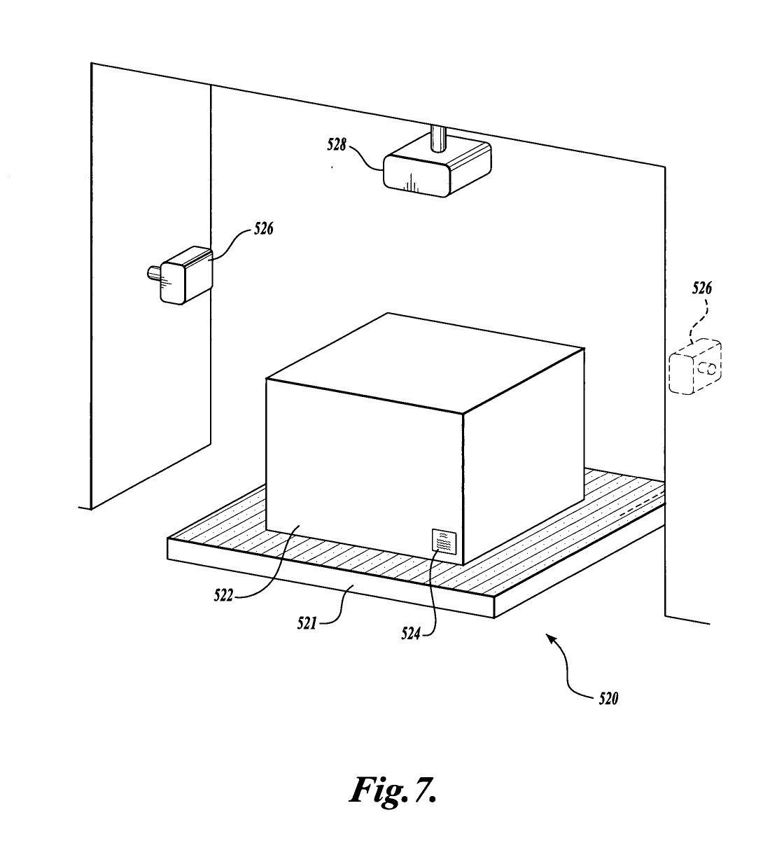

In the illustrated embodiment of FIG. 1, one repeater 26 is positioned on the external surface of the container body 22. In other embodiments, multiple repeaters may be positioned on the same container in proximity to the RFID tag(s). In yet other embodiments, the repeater(s) are positioned in proximity to, but not on, the container. For example, in one embodiment, the repeater(s) may be positioned inside the container. In another embodiment, as shown in FIG. 7, the repeaters 526 may be positioned in the reader system or within the general area of the reader 528.

The term “in proximity” is defined herein as located at a distance, considering system limitations and signal attenuation factors including absorption and reflection, such that the transmitted signal from the reader or the repeater reaches the RFID tag, and vice-versa. Hence, when the repeater is “in proximity” to the RFID tag, the reader, or another repeater, it may be located on the container, in the container, on another container, on a pallet supporting the container, next to the container, on the reader, near the reader, within the reader system, near another repeater, or in any other location in which a signal is capable of transmitting between the repeater and the RFID tag, between the repeater and the reader, or between any two intermediate repeaters, considering distance, RFID tag limitations, and signal attenuation factors.

Thus, the positioning of repeaters and the number of repeaters used within a system depends upon the reading environment, the physical make-up of the container, the number and orientation of the RFID tags to be read, the nature of the goods being contained, the limitations of the RFID tags, the strength of the reader, and the strength of the repeaters themselves. Such a repeater system can be optimized for enhanced readability based on these as well as other factors.

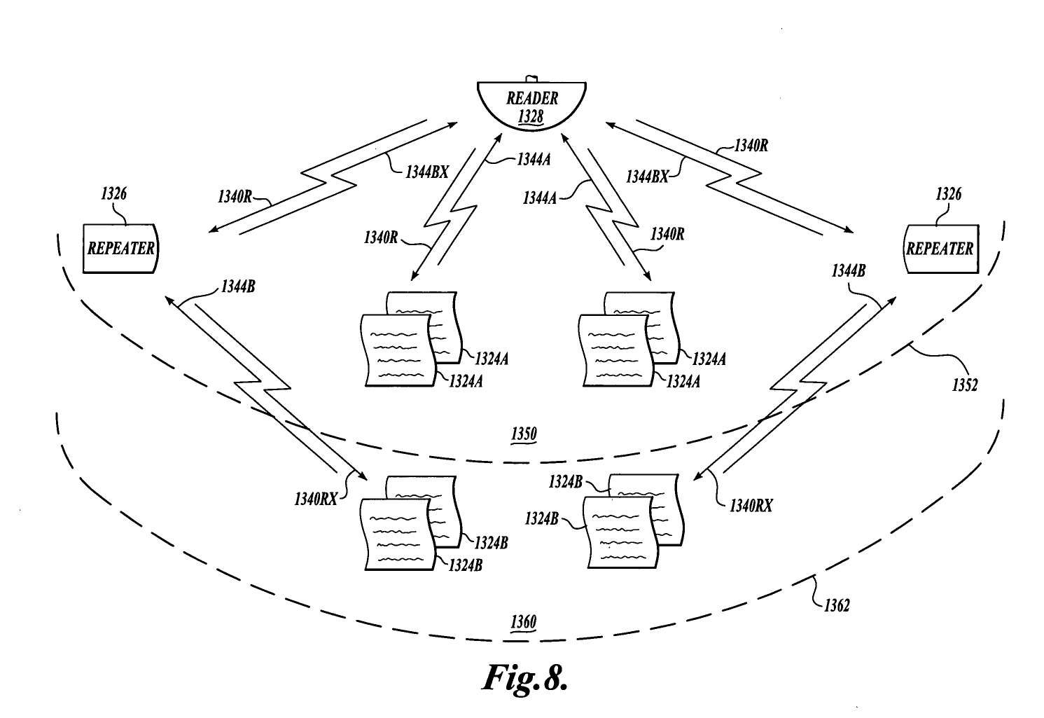

Referring now to FIG. 4, another embodiment of a radio frequency identification system 320 is illustrated, in which RFID tags 324A (top set) and 324B (bottom set) are located on each of the stacked goods 330 disposed within container 322. The system 320 includes a plurality of repeaters 326 configured for parallel operation (shown in FIG. 4 as two repeaters 326) located on the external walls of the container 322. Referring now to FIG. 8, there is shown a functional block diagram of the radio frequency identification system depicted in the exemplary embodiment of FIG. 4. In that regard, the RFID tags 324A (top set) and 324B (bottom set) located on goods 330 are represented by blocks 1324A and 1324B; the repeaters 326 are represented by blocks 1326; and the reader 328 is represented by block 1328. As will be discussed in detail below, arrows 1340R, 1340RX, 1344A, 1344B, and 1344BX in FIG. 8 represent the radio frequency signals sent from the reader 328, the RFID tags 324A and 324B, and the repeaters 326 (FIG. 4).

With reference to FIG. 8, communication within the system during use occurs as follows. First, the reader 1328 transmits a radio frequency interrogation signal 1340R that travels within a certain area, known as the reader communication field 1350 marked by reader communication field boundary 1352. The size (or area) of the reader communication field 1350 depends on multiple contributing factors, including reader signal strength, as well as signal losses due to absorption and reflection. Second, and as discussed above, when RFID tags 1324A pass through or are located within the reader communication field 1350, the RFID tags 1324A detect the reader interrogation signal 1340R and respond by transmitting their own radio frequency response signals 1344A, each carrying content and identification data associated with the respective RFID tags 1324A. Next, the reader 1328 detects the response signals 1344A transmitted from the RFID tags 1324A and decodes or demodulates the radio frequency signals 1344A to obtain the associated data, as known in the art.

In situations in which RFID tags are outside the reader communication field 1350, such as RFID tags 1324B as shown in FIG. 8, radio frequency repeaters 1326 may be used to provide, for example, an extended radio frequency signal 1340RX such that the reader 1328 is able to communicate with the RFID tags 1324B. To that end, for active repeaters, when repeaters 1326 pass through or are located within the reader communication field 1350, the repeaters 1326 detect the reader interrogation signal 1340R and respond by retransmitting the same interrogation signal 1340R as repeater signal 1340RX in multiple directions, thus extending the reader communication field 1350 to carry to the RFID tags 1324B, known as the repeater communication field 1360 marked by repeater communication field boundary 1362. For passive repeaters, the repeaters 1326 receive radio frequency energy from the reader signal 1340R, and store and reradiate the reader signal 1340R as repeated signal 1340RX in multiple directions. Like the reader communication field 1350, the size (or area) of the repeater communication field 1360 depends upon multiple contributing factors, including repeater signal strength, as well as signal losses due to absorption and reflection.

When RFID tags 1324B pass through or are located within the repeater communication field 1360, the RFID tags 1324B detect the repeater signal 1340RX (which is the retransmitted or reradiated reader interrogation signal 1340R) and respond by transmitting their own radio frequency signals 1344B carrying associated content and identification data. The reader 1328 (or in some cases, as will be discussed below, a repeater 1326) then detects the radio frequency signals 1344B transmitted from the RFID tags 1324B and decodes or demodulates the radio frequency signals 1344B to obtain the associated data.

As discussed above, reader antennas in general may have stronger signal reception capabilities than the RFID tag antennas, enabling them to more readily detect attenuated signals. Thus, in some circumstances, the response signals 1344B transmitted from the RFID tags 1324B may be received by the reader 1328 without the aid of a repeater 1326. However, in other circumstances in which the reader 1328 cannot read the radio frequency signals 1344B transmitted by the RFID tags 1324B, the repeaters 1326 may also repeat the radio frequency signals 1344B in much the same way as they repeat the reader interrogation signal 1340R as repeated signal 1340RX. That is, the repeaters 1326 detect the radio frequency signals 1344B of RFID tags 1324B and respond by retransmitting (or reradiating) the same radio frequency signals 1344BX, thereby extending the RFID tag communication field (not shown) such that these responsive signals 1344B may carry back to the reader 1328.

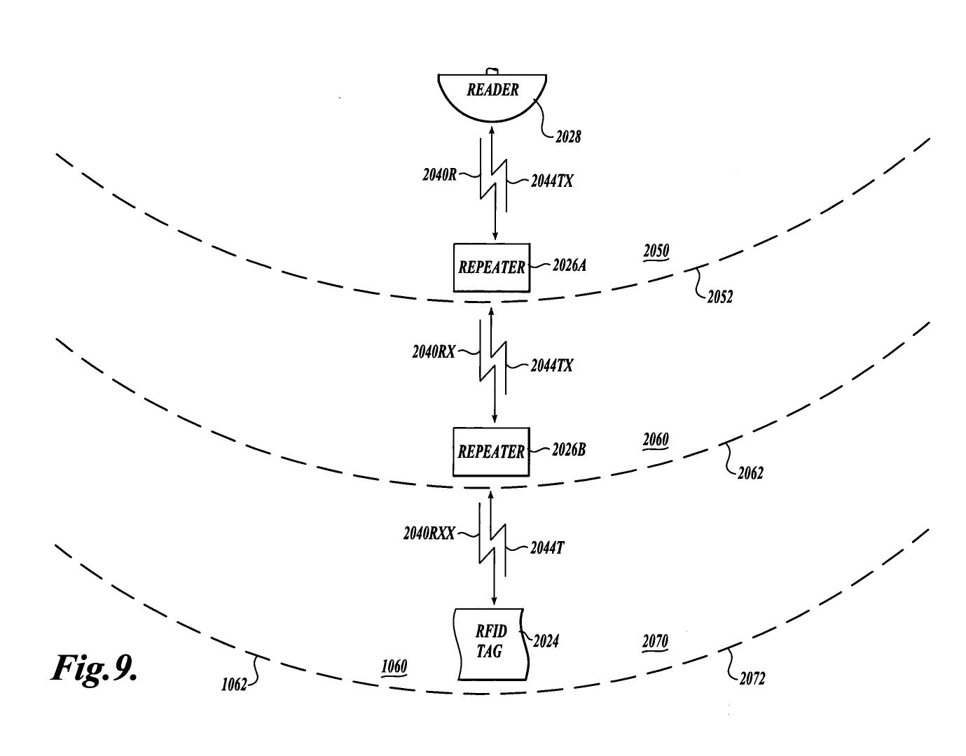

Although the repeaters 1326 in the illustrated embodiment of FIG. 8 operate in parallel within the system, it will be appreciated that any number of repeaters operating in series within a system to carry reader interrogation signals to RFID tags or response RFID tag signals back to the reader is also within the scope of the embodiments of the present invention. Referring now to the non-limiting example of FIG. 9, there is shown a functional block diagram of a radio frequency identification system including a plurality of repeaters in series (shown in FIG. 9 as two repeaters in series) represented by blocks 2026A and 2026B; a reader represented by block 2028; and an RFID tag represented by block 2024.

With reference to FIG. 9, communication within the exemplary series repeater system during use occurs as follows. First, the reader 2028 transmits a radio frequency interrogation signal 2040R that travels within a certain area, known as the reader communication field 2050 marked by reader communication field boundary 2052. Second, as the first repeater 2026A passes through or is located within the reader communication field 2050, the first repeater 2026A detects the reader interrogation signal 2040R. The first repeater 2026A responds by transmitting (or reradiating for a passive repeater) a repeated interrogation signal 2040RX that travels within a certain area, known as the first repeater communication field 2060 marked by first repeater communication field boundary 2062. Third, as the second repeater 2026B passes through or is located within the first repeater communication field 2060, the second repeater 2026B detects the repeated reader interrogation signal 2040RX and responds by transmitting (or reradiating for a passive repeater) a second repeated interrogation signal 204ORXX that travels within a certain area, known as the second repeater communication field 2070 marked by second repeater communication field boundary 2072. Fourth, when RFID tag 2024 passes through or is located within the second repeater communication field 2070, the RFID tag 2024 detects the second repeated interrogation signal 204ORXX and responds by transmitting a response signals 2044T, carrying content and identification data associated with the RFID tag 2024. The reader 2028 detects the response signal 2044T transmitted from the RFID tag 2024 and decodes or demodulates the radio frequency signals 2044T to obtain the associated data, as known in the art.

As discussed above, in some circumstances, the response signal 2044T transmitted from the RFID tag 2024 may be received by the reader 2028 without the aid of the repeaters 2026A and 2026B. However, in other circumstances in which the reader 2028 cannot read the radio frequency signals 2044 transmitted by the RFID tag 2024, the repeaters 2026A and 2026B may also repeat the RFID response signal 2044T in much the same way as they repeat the reader interrogation signal 2040R as repeated signals 2040RX and 2040RXX, as shown by arrows 2044TX and 2044TXX.

It will be appreciated that RFID tags and repeaters may be configured to apply conventional radio frequency techniques to prevent signal collision, such as responding to the reader interrogation signal at delayed or different time intervals. It is further contemplated that different operating frequencies may be used for different communication purposes, for example, an RFID tag may have a first circuit for receiving power (in the case of a passive RFID tag) and a second resonant circuit for reading or interrogation. In addition, a different operating frequency may be used for transmitting interrogation signals from the reader to the RFID tags than is used for transmitting response signals back from the RFID tags to the reader.

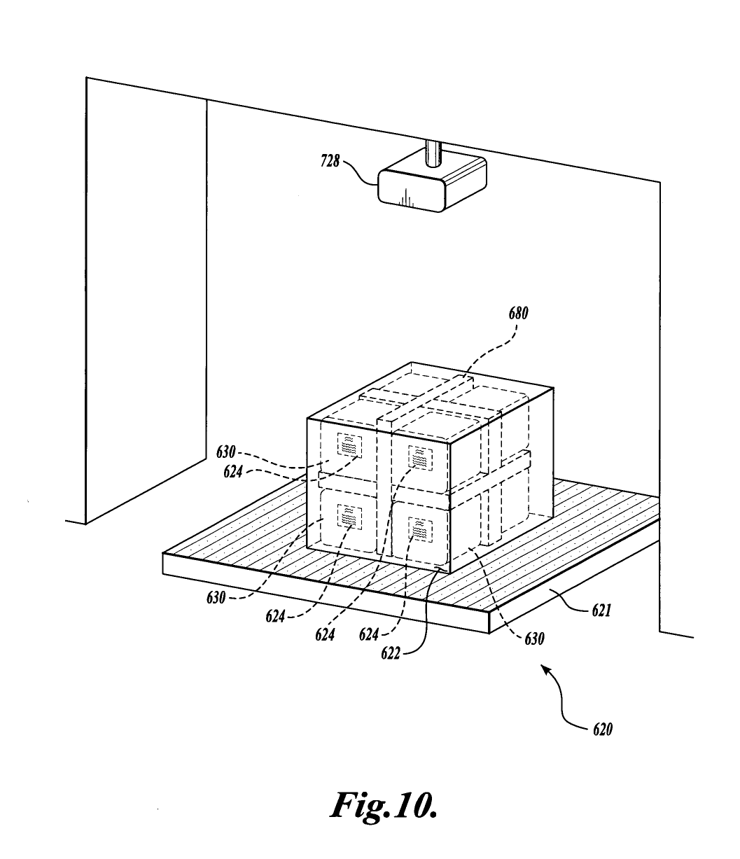

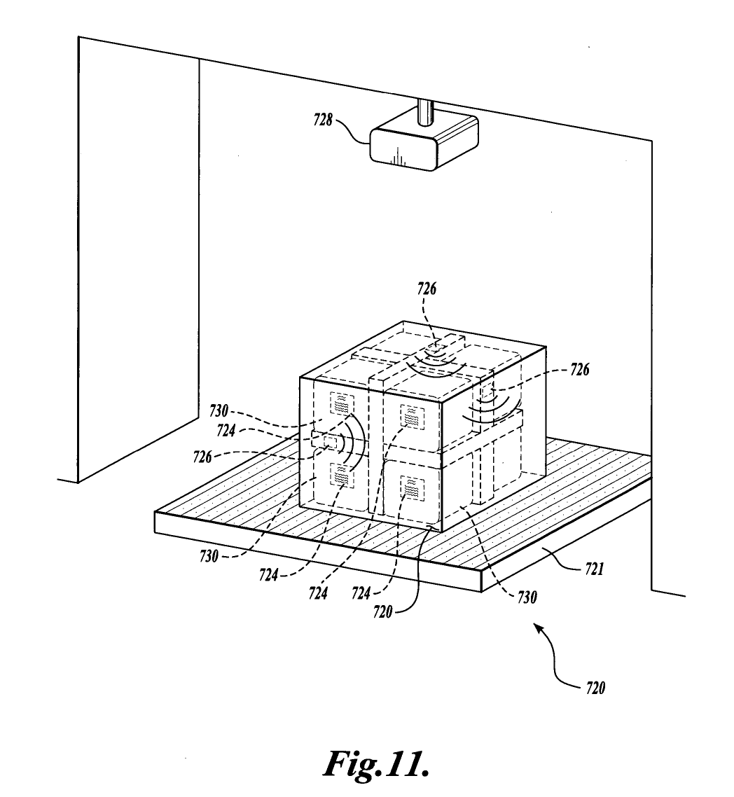

Now referring to FIGS. 10 and 11, combination container and radio frequency identification systems constructed in accordance with other embodiments of the present disclosure will be described in greater detail. The systems are substantially identical in materials and operation as the previously described embodiment with the exception that the radio frequency device of the previous embodiment is a spacing material for enhancing readability of the RFID tag. Although spacing material is another example of a radio frequency device for enhancing readability of a radio frequency signal, it will be appreciated that other suitable enhancement systems or methods for improving RFID tag performance are also within the scope of the invention.

Spacing material within the scope of the present disclosure includes corrugated paperboard, organic or inorganic foams, paper, wood, and air, as well as any combinations thereof, or any other spacing material known or used in the art. Such spacing material is generally a low-density, non-conducting material providing minimal signal redirection and/or attenuation over distance beyond natural signal attenuation through dry air. Moreover, spacing material within the scope of the present enclosure may come in many forms, including panel-form, pallet-form, loose peanut-form, spray foam, form-fitted for specific goods, air bag form, or in any other dimension or form.

As seen in FIG. 10, spacing material or spacing panels 680 are disposed within the container 622 body between the goods 630. Goods (depending on their nature, composition, and packaging) can be a source of signal redirection and/or attenuation. For example, in the illustrated embodiment of FIG. 4, the goods 330 are closely packed adjacent to one another, and, depending on their physical make up, may not enable the readability of all radio frequency signals transmitted from the RFID tag 324A and 324B, particularly RFID tags located between any adjacent goods 330. The spacing panels 680 in the illustrated embodiment of FIG. 10 thus provide pathways of lower signal redirection and/or attenuation for radio frequency signals to travel through the container body 622 to and from all RFID tags 624 located on goods 630 than the pathways would be if the goods 630 were closely packed adjacent to one another. As non-limiting examples, the spacing panels 780 may be corrugated linerboard panels, organic or inorganic foam panels, air panels (such as panel-shaped air bags), or panels made from any other spacing material known and used in the art.

In other embodiments, spacing material may be used in other locations other than being disposed within the container body. As non-limiting examples, spacing material may be used underneath containers (such as supporting or spacing pallets), between containers (such as spacing panels between a plurality of boxes), as liners on store shelving, or in other locations to enhance readability of radio frequency signals.

In another embodiment, spacing material may be used in conjunction with at least one active or passive repeater to further enhance signal communication and RFID tag performance. As seen in FIG. 11, repeaters 726 are attached to the spacing panels 780 disposed within the container 722 body to enhance the readability of radio frequency signals transmitted from the RFID tags 724.

Such repeater/spacing panels 780 can be disposable, or recoverable and re-useable in subsequent container 722 shipments. For example, the repeater/spacing panels 780 can be removed from the container 722 and reused in association with another container 722. As a non-limiting example, repeater/spacing panels 780 can be used in a shipment between multiple containers to enhance readability of radio frequency signals transmitted from RFID tags. After those RFID tags associated with those containers have been read or otherwise processed, the repeater/spacing panels 780 can be removed from their existing construction, and reused with a subsequent shipment of multiple containers.

The repeater/spacing panels 780 in the illustrated embodiment of FIG. 11 are constructed by attaching repeaters 726 to spacing panels. As non-limiting examples, the repeaters 726 can be attached by adhesive, stapling, or other chemical or mechanical attachment devices. As other non-limiting examples, the repeaters 726 may be imbedded within the spacing panel 780. For example, the spacing panel 780 is formed in accordance with methods well-known in the art, with the repeater imbedded within the spacing material forming the spacing panel 780.

While several embodiments of the invention have been illustrated and described, it will be appreciated that various changes can be made therein without departing from the spirit and scope of the invention.

The embodiments of the invention in which an exclusive property or privilege is: claimed are defined as follows:

1. A combination container and radio frequency identification system, comprising:
(a) at least one container having a container body;
(b) a radio frequency identification tag associated with the at least one container body, wherein the radio frequency identification tag is capable of transmitting a radio frequency signal; and
(c) at least one discrete radio frequency device associated with the radio frequency identification tag or the at least one container body for enhancing readability of the radio frequency signal.

2. The system of claim 1, wherein the at least one discrete radio frequency device is a radio frequency signal repeater.

3. The system of claim 2, wherein the radio frequency signal repeater is an active repeater.

4. The system of claim 2, wherein the radio frequency signal repeater is a passive repeater.

5. The system of claim 2, wherein the location of the radio frequency signal repeater is selected from the group consisting of: inside the at least one container body, on the external surface of the at least one container body, on the external surface of the at least one container body, remote of the at least one container body, inside the at least one container body, and within spacing material associated with the at least one container body.

6. The system of claim 3, wherein the active repeater enhances the readability of the radio frequency signal from the radio frequency reader by receiving a signal transmitted from the reader, amplifying the signal, and retransmitting the signal in the direction of the radio frequency identification tag.

7. The system of claim 3, wherein the active repeater enhances the readability of the radio frequency signal from the radio frequency reader by receiving a signal transmitted from the radio frequency identification tag, amplifying the signal, and retransmitting the signal in the direction of the reader.

8. The system of claim 4, wherein the passive repeater enhances the readability of the radio frequency signal from the radio frequency reader by receiving a signal transmitted from the reader, and reradiating the signal in the direction of the radio frequency identification tag.

9. The system of claim 4, wherein the passive repeater enhances the readability of the radio frequency signal from the radio frequency reader by receiving a signal transmitted from the radio frequency identification tag, and reradiating the signal in the direction of the reader.

10. The system of claim 1, wherein the at least one discrete radio frequency device is a plurality of radio frequency signal repeaters.

11. The system of claim 1, wherein the at least one container is selected from the group consisting of a box and a pallet supporting a plurality of boxes.

12. The system of claim 1, wherein the at least one container is a plurality of containers.

13. The system of claim 1, wherein the at least one discrete radio frequency device is spacing material associated with the container.

14. The system of claim 1, wherein the spacing material is corrugated linerboard.

15. The system of claim 1, wherein the at least one discrete radio frequency device is a repeater associated with spacing material.

16. A method of increasing readability of a radio frequency identification tag, comprising:
(a) obtaining a container;
(b) associating at least one radio frequency identification tag with the container, wherein the at least one radio frequency identification tag is capable of transmitting a radio frequency signal; and
(c) associating at least one radio frequency device with the radio frequency identification tag or the container, wherein the at least one radio frequency device enhances readability of the radio frequency signal.

17. In a combination container and radio frequency identification system of the type including a container having a radio frequency identification tag capable of transmitting a radio frequency response signal, and a radio frequency reader capable of transmitting a radio frequency interrogation signal, a method of increasing readability of the radio frequency identification tag by the radio frequency reader, comprising:
(a) receiving the interrogation signal transmitted from the reader or receiving the response signal transmitted from the radio frequency identification tag; and
(b) enhancing the received interrogation signal to enable readability by the radio frequency identification tag or enhancing the received response signal to enable readability by the reader.

18. The method of claim 19, wherein enhancing includes amplifying.

19. The method of claim 19, wherein enhancing includes retransmitting or reradiating.

20. The method of claim 19, wherein enhancing includes minimizing interference.
